(19) United States
(12) Patent Application Publication
(10) Pub. No.: US 2024/0411294 A1
(43) Pub. Date: Dec. 12, 2024

(54) PRESCRIPTIVE INTELLIGENT SYSTEM FOR MOBILE INDUSTRIAL WORKERS

(71) Applicant: Aveva Software, LLC, Lake Forest, CA (US)

(72) Inventors: Moresh Wankhede, Dartford (GB); Leon Parsons, St. Ives (GB); Merylatha Meriyani, Hyderabad (IN); Timothy Cliff, St. Ives (GB)

(21) Appl. No.: 18/736,796

(22) Filed: Jun. 7, 2024

Related U.S. Application Data
(60) Provisional application No. 63/471,591, filed on Jun. 7, 2023.

(51) Int. Cl. G05B 19/418

(52) U.S. Cl. CPC G05B 19/4184; G05B 19/4183; G05B 2219/31439

(57) ABSTRACT

A prescriptive intelligent system is provided for mobile industrial workers At least one data lake stores data associated with industrial assets and processes. At least one orchestration engine applies at least one information standard to at least one ingestion pipeline, which is enabled to process data from the at least one data lake and use artificial intelligence algorithms that identify actionable insights in the data, wherein actionable insights comprise solutions implemented in historical environments and feasible for other environments. A system stores the data as a knowledge graph across different types of technology components for user interfaces. A user interface responds to an excursion associated with an industrial asset and/or process by providing an overview of at least one of an industrial asset and/or process, an alarm, a root cause analysis, and/or a prescribed solution, and coordinates outputs from some of the different types of technology components.

### CROSS REFERENCE TO RELATED APPLICATION

This application claims priority under 35 U.S.C. § 119 or the Paris Convention from U.S. Provisional Patent Application 63/471,591, filed Jun. 7, 2023, the entire contents of which are incorporated herein by reference as if set forth in full herein.

### BACKGROUND

As companies accelerate their digital transformations towards more autonomous operations, the problem facing most is how to strategically implement such transformations. The increasing level of autonomy associated with such transformation reduces the level of human presence. However, the number of assets in industrial facilities such as manufacturing plants and refineries continue to increase due to the ever-increasing complexities of the processes involved. These trends result in fewer human operators who are responsible for maintaining more industrial assets, which include pumps, fans, dampeners, generators, valves, and control systems, as non-limiting examples. Increased industrial complexity and reduced personnel presence create a problem that needs a solution where ‘in-the-moment’ workers who need to repair or replace a broken asset spend less time searching for information to reduce the amount of downtime.

In a typical scene in a control room during a critical event, the operators review multiple systems and databases while discussing with each other possible root causes. In environments that have been affected by economic reductions or attrition, the knowledge of how best to address the system often leaves with an operator. Even if a solution is present in the historical record, locating the information in a timely fashion (or at all) is challenging at best, which can create the chaotic nature of multiple personnel simultaneously searching for solutions to an emergency situation.

### DRAWING DESCRIPTION

FIG. 1 depicts an example of an industrial asset which can be used in two different manufacturing environments according to some embodiments.

FIG. 2 shows an example of a perspective of a user interface when an excursion occurs according to some embodiments.

FIG. 3 illustrates an example of a knowledge graph architecture according to some embodiments.

FIG. 4 shows an implementation of the system architecture according to some embodiments.

FIG. 5 shows components of the system architecture including a common user interface framework according to some embodiments.

FIG. 6 shows aspects of the system architecture that includes data loading and mapping according to some embodiments.

FIG. 7 shows an overview of different aspects of the system architecture according to some embodiments.

FIG. 8 illustrates further aspects of the system architecture according to some embodiments.

FIG. 9 depicts a flowchart that illustrates an example computer-implemented method for a prescriptive intelligent system for mobile industrial workers according to some embodiments; and

FIG. 10 depicts example components that provide aspects of the system according to some embodiments.

FIG. 11 shows an example XR engine that includes various modules according to some embodiments.

FIG. 12 shows an example cloud system according to some embodiments.

FIG. 13 shows the exemplary computer-based systems/platforms, the exemplary computer-based devices, and/or the exemplary computer-based components of the present disclosure according to some embodiments.

FIG. 14 illustrates a schematic diagram showing an example embodiment of a client device that may be used within the present disclosure according to some embodiments.

FIG. 15 shows the system integrated into a process model according to some embodiments.

### DETAILED DESCRIPTION

In developing an increase in industrial plant autonomy, which still requires an active human presence who retain responsibility for the plant, the system includes a knowledge graph integrated with a manufacturing control system, a data acquisition system, and/or a data analytics system. The system improves the ‘in-the-moment’ decision making process by providing a knowledge graph-as-a-service which converts any operator into an expert operator, resolving the challenge of workers not being able to readily access and understand asset information to resolve problems with asset functionality. The system can include a cloud-based integration platform that automates integration of solutions implemented in multiple disparate manufacturing environments to enable access of all operators to the “wisdom of the collective.”

In embodiments, a prescriptive intelligent system is provided for mobile industrial workers. At least one data lake stores data associated with industrial assets and industrial processes. At least one orchestration engine applies at least one information standard to at least one ingestion pipeline, which is thereby enabled to process data from the at least one data lake and use artificial intelligence algorithms which identify actionable insights in the data, wherein actionable insights comprise solutions implemented in historical environments and feasible for other environments. A system stores the data as a knowledge graph across different types of technology components for user interfaces. A user interface responds to an excursion associated with an industrial asset and/or an industrial process by providing an overview of at least one of an industrial asset and/or an industrial process, an alarm, a root cause analysis, and/or a prescribed solution, and coordinates outputs from some of the different types of technology components.

For example, a data lake house stores Acme Energy Corporation's manufacturing data that includes Acme's power plants and wind turbines, which use many industrial assets, such as axial fans. Many orchestration engine applies many information standards to many ingestion pipelines to process data from the data lake house and use machine-learning models to identify actionable insights in the data. One such insight is the operators in the power plants respond to axial fans overheating by investigating blockages in a fan's airflow and incorrect electrical supply and worn bearings for the fan's motor, while operators at the win turbines have corrected problems with overheating axial fans through air flow and electrical supply solutions, but not with a bearing solution. The system stores the data as a knowledge graph across different types of user interface technology components, which provide overviews, 3-D depictions, and key performance indicator for malfunctioning assets. When an axial cooling fan for a wind turbine begins to overheat, a dashboard outputs an alarm, an overview, and a 3-D depiction of the fan to an operator, along with a suggestion to investigate a novel root cause for overheating fans at Acme's wind turbines: check the fan's motor bearings for excessive wear because the fan's inlet air flows and the motor's electrical supply are normal, but the motor's bearing temperatures are high.

Consequently, the system links the knowledge of multiple individuals, both past and present, using a cohesive knowledge graph according to some embodiments. The knowledge graph may analyze current manufacturing conditions and inputs from multiple operators and systems to guide a user to most the efficient solution. The knowledge graph integrates the operation data and/or engineering data as well as the context visualization platform. In some non-limiting embodiments, the system can integrate with peripheral platforms where the system can receive input from the peripheral platforms and/or send collective knowledge to other peripheral platforms for analysis.

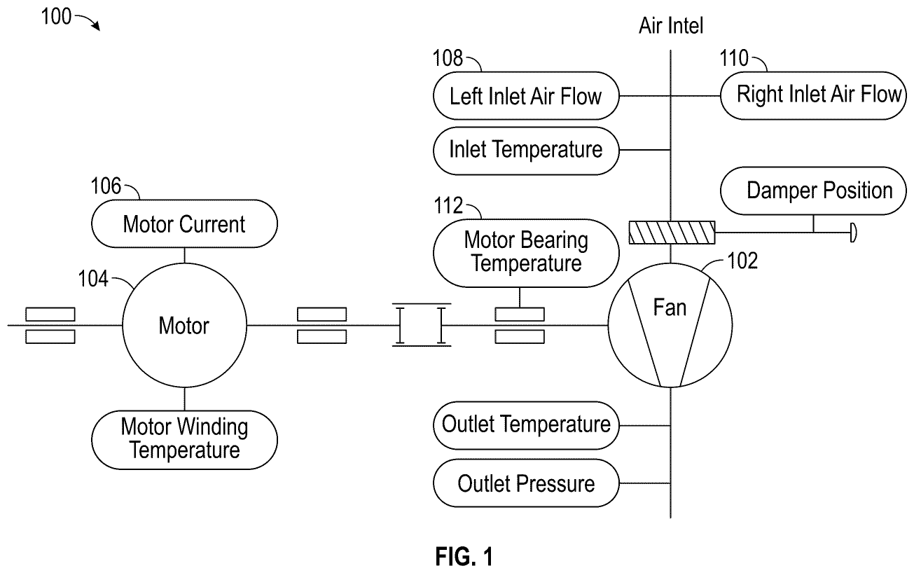

FIG. 1 depicts an example of an industrial asset 100 that can operate in multiple different manufacturing environments according to some embodiments. The manufacturing environments may include a thermal power plant and a wind turbine, where an industrial fan 102 driven by a motor 104 can either supply air in a thermal power plant or cool electronics in the nacelle of a wind turbine. The fan 102, which may be referred to as an axial fan 102, may be a critical industrial asset, such that the failure of the fan 102 in either environment must be immediately addressed because the fan 102 can completely stop operations. Therefore, many operating conditions of the fan 102 and the motor 104 may be continuously monitored, such as the motor current 106, the left inlet air flow 108 and the right inlet air flow 110 for the fan 104, and the motor bearing temperature 112.

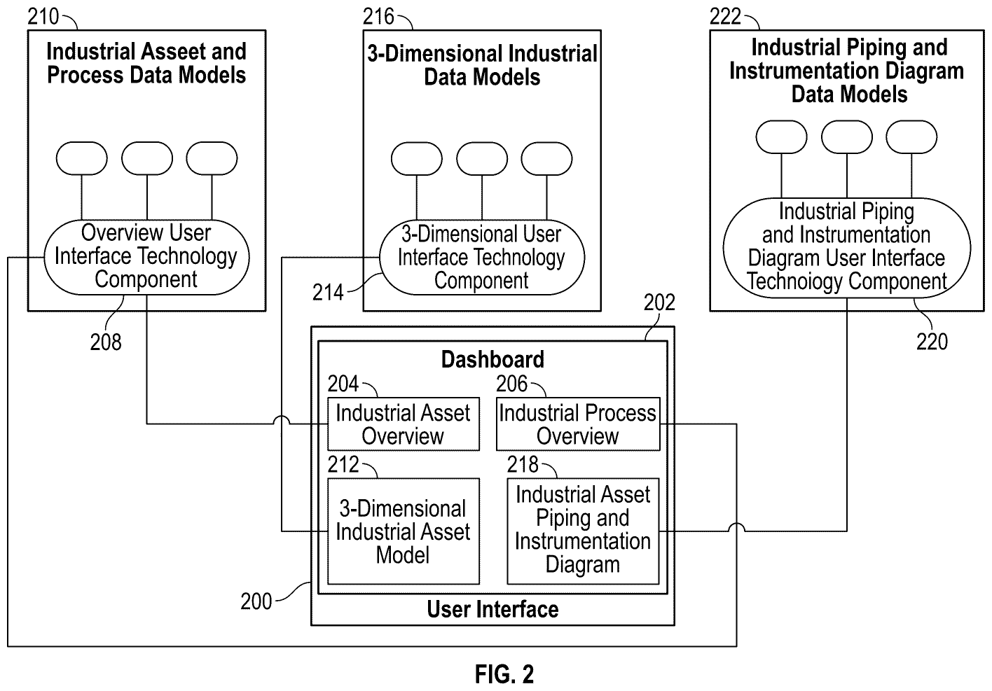

FIG. 2 shows a perspective of an example user interface 200 when an excursion occurs according to some embodiments. The system can use a system knowledge graph and interface with a peripheral platform to display the user interface 200 that includes a dashboard 202 which can provide an industrial process overview 204, and/or an industrial asset overview 206, which may be provided by an overview user interface technology component 208, based on industrial asset and process data models 210. The dashboard 202 can supplement the overviews 202 and 204 with a 3-dimensional industrial asset model 212, which may be provided by a 3-dimensional user interface technology component 214, based on 3-dimensional industrial data models 216. The dashboard 202 may further supplement the overviews 204 and 206 with an industrial asset piping and instrumentation diagram 218 provided by an industrial piping and instrumentation diagram user interface technology component 220, based on industrial piping and instrumentation diagram data models 222.

The dashboard 202 can include a default summary view that enables a user to view all properties including engineering metadata. Another default summary view can enable a user to look at a 3-dimensional view of an industrial plant, which may be provided by the 3-dimensional user interface technology component 214, based on the 3-dimensional industrial data models 216. The dashboard 202 can also display a live trend of a key performance indicator of the operation of an industrial plant in yet another default view. An additional default view may include a piping and instrumentation diagram or at the industrial plant level for any assessment that a worker needs to perform, as provided by the industrial piping and instrumentation diagram user interface technology component 220, based on the industrial piping and instrumentation diagram data models 222. When an excursion occurs, the system can generate a critical alarm and push the alarm to a worker via dashboard 202, as enabled by a knowledge graph.

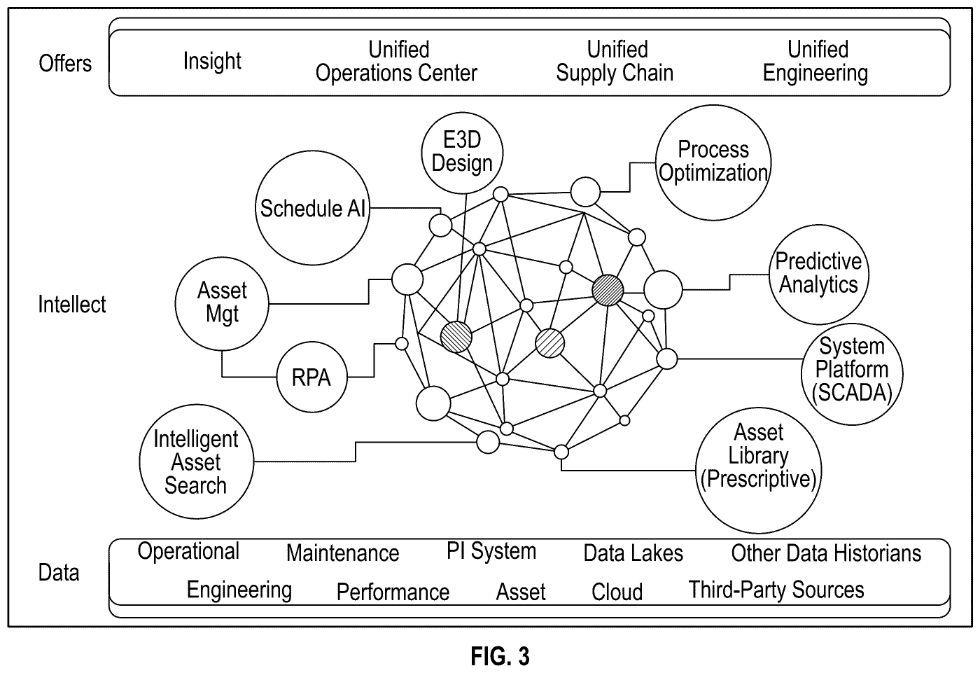

FIG. 3 illustrates an example of a knowledge graph architecture 300 according to some embodiments. The knowledge graph architecture 300 can include various types of data, such as engineering data, operational data, and maintenance data.

Engineering data can be, but is not limited to, 1D, 2D, 3-dimensional, 4D and/or 5D data. For example, the 1D engineering data can correspond to and/or include 1D simulations that assist engineering users in understanding the interaction of different components within a system. Accordingly, such simulations, whether 1D or 5D, for example, can provide design information for a broad range of mechanical, electronical, pneumatic and/or hydraulic industries (e.g., construction, oil refinery, shipbuilding, aerospace, automotive, and the like). Accordingly, the engineering data can enable the renderings of the interaction of components with their surroundings (e.g., 2D/3-dimensional data), in addition to an entire design of a system and the systems components' interactions (e.g., 1D data). As such, such data can include the parameters of the physical models of assets and/or endpoint spaces (e.g., design, structure and make-up information, for example).

Operational data can include the physical properties and the mechanisms for which assets operate within a space/endpoint. For example, operational data can include PI/ADH, AIM-A/Insight, and the like.

Maintenance data can include data integration and transformation software data which allows users to develop and execute workflows. Such maintenance data can correspond to parameters related to efficiency operations, anomalies, errors, fixes, patches, and the like, or some combination thereof. Maintenance data can enable intelligent asset management, which can involve SAP data and/or applications, Maximo data and/or applications, and/or any other type of application or software suite that enables maintenance operations for a digital/virtual environment, or some combination thereof. 3-dimensional data can include any type of known or to be known 3-dimensional data that can be generated (e.g., via scanning and creating 3-dimensional representations), searched and identified, requested, or otherwise identified, and can correspond to CAD, point clouds (e.g., Laser Point Clouds, for example), LiDAR, photogrammetry, meshes, parametric models, depth-maps, RGB-D, multi-view images, voxels or constructive solid geometry, and the like.

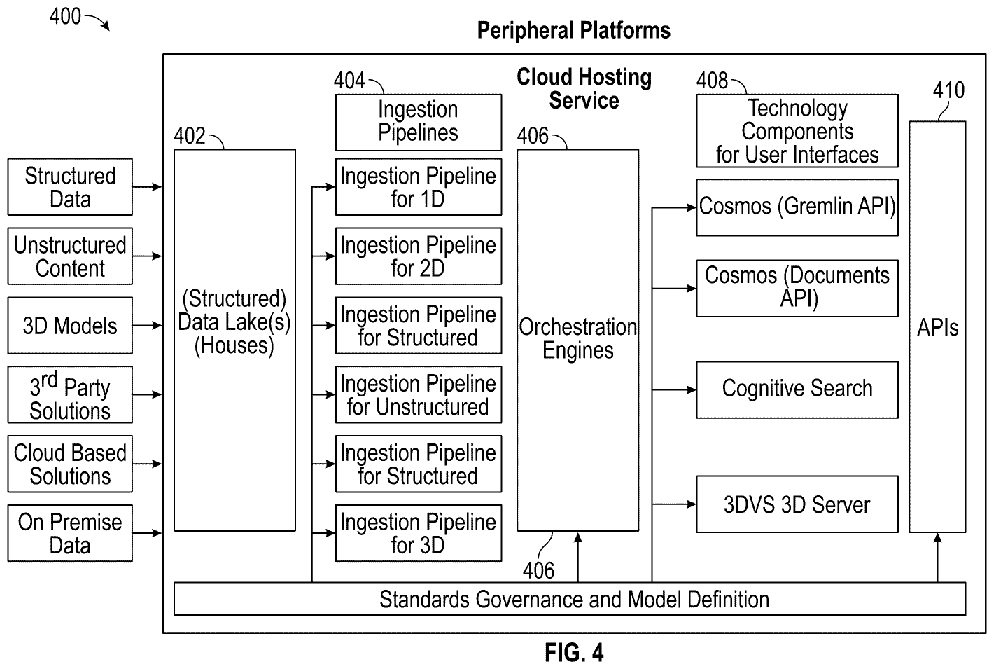

FIG. 4 shows an implementation of the system architecture 400 according to some embodiments. The system architecture 400 can include data lakes 402, ingestion pipelines 404, orchestration engines 406, technology components for user interfaces 408, and system or platform application programming interfaces (APIs 410).

The system 400 can upload an industrial asset's data and/or process data and/or content files to be stored in one or more data lakes 402 (or one or more data lake houses 402). If the data lake 402 allows partitioning to help identify deltas, or is structured in another way, then the data lake 402 may be referred to as a data lake house 402. The data lake 402 can receive and store historical industrial asset (equipment) data, root cause analysis, implemented solutions, and/or post implementation performance, all of which are stored with no changes, mapping, and/or interpretations, thereby improving the process delta recognition by the system 400. At least one (or all) historic versions of the files are retained.

The ingestion pipelines 404 can take data and content from the data lake 402, analyze the data and contents using artificial intelligence and/or machine learning algorithms to identify patterns and develop actionable insights, such as identifying additional “enriched” data and content from the data lake 402, to process the data/content in a ‘tailored’ fashion from the data lake 402 based on rules/mapping provided by one of many information standards, and/or to provide additional “enriched” context of the data and contents. The “enriched” additional data and content provides additional information and actionable insights, which are subsequently made available to platform application programming interfaces 410. Using the artificial intelligence and/or machine learning algorithms allows the system 400 to potentially find information/insights more easily or find information/insights which no individual human or currently available operator have.

The data and content and the additional “enriched” data and content may then subsequently be provided to the platform application programming interfaces 410. The ingestion pipelines 404 may process the data and contents, and any additional “enriched” data and content, from the data lake 402 based on rules and mapping provided by information standards and the models defined in information standards. The same information standards and mapping may be applied to all data from all sources ensuring that there are compatible, consistent, and coherent models across of the sources of data. Each of the ingestion pipelines 404 is tailored to its data source to ensure that it is correctly processed, and mappings and standards are applied in the correct manner.

The orchestration engines 406 orchestrate the running of the ingestion pipelines 404, which can process data and content using artificial intelligence and/or machine learning algorithms, and can apply information standards to each ingestion pipeline 404, ensuring that the correct information standard is applied for each ingestion pipeline 404.

The system 400 may include model persistence, where the knowledge graph is stored by the system 400 across different types of user interface technology components 408, where each of the different types of user interface technology components 408 can provide a set of capabilities to support the knowledge graph's use, such as a set of analysis tools and/or a connection to a peripheral platform that supports root cause analysis. The user interface technology components 408 are configured via information standards so that the shape and behavior of the data conforms and allows. The system 400 to coordinate two or more technology components 408 to act as a single whole through automated component configuration.

The application programming interfaces 410 give access to the data and services provided by the system 400 and/or are configured by the information standards driving the model. This allows the responses by the application programming interfaces 410 to be tailored by a user to fit particular use cases and data to be returned following different information standard models. The behavior by the application programming interfaces 410 also allows a response to be blended from data and content from different technology components 408 in a coherent way, which allows more capabilities to seamlessly be added from peripheral platforms. Information standards may specify a model and a set of technology specific configurations that allow the system 400 to be comprised of several different user interface technology components 408 and behave as if it were a single configured user interface technology component 408.

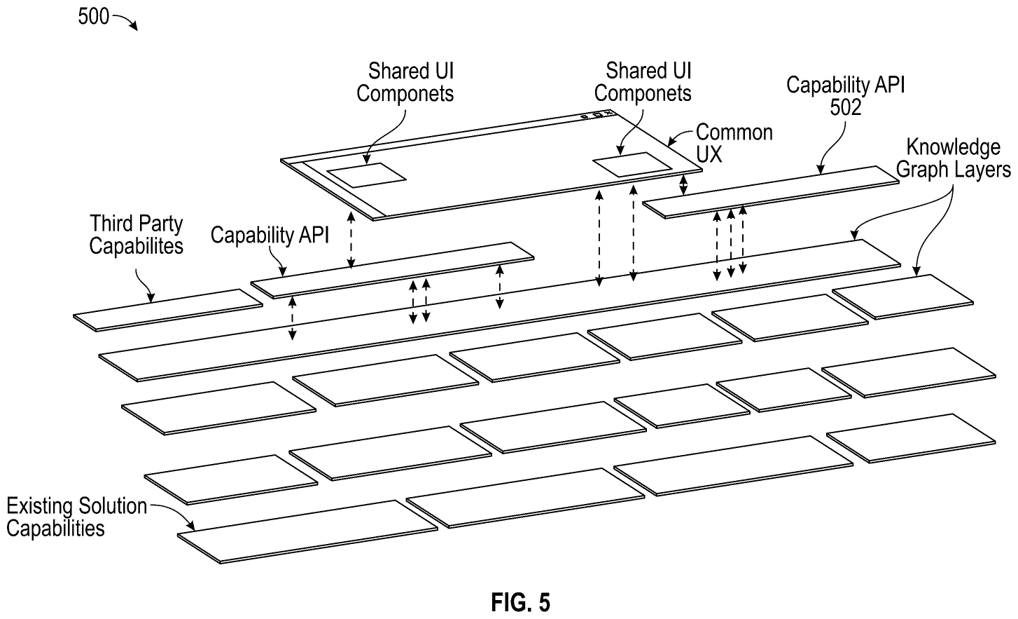

FIG. 5 shows components of the system architecture 500 including a common user interface (UX) framework 502 according to some embodiments. The system can include a peripheral platform that includes a common user interface framework 502 that is used to access the knowledge graph data to execute a command to integrate different user interface technologies. The system architecture may be designed (as a platform) to federate different services (both existing and new) allowing the user interface to be changed over time with minimal input by a user. The system architecture may consume services from at least one virtual reality and/or augmented reality (XR) peripheral platforms in a common way which enables interactions with 3-dimensional environments to drive other technologies' components on the screen.

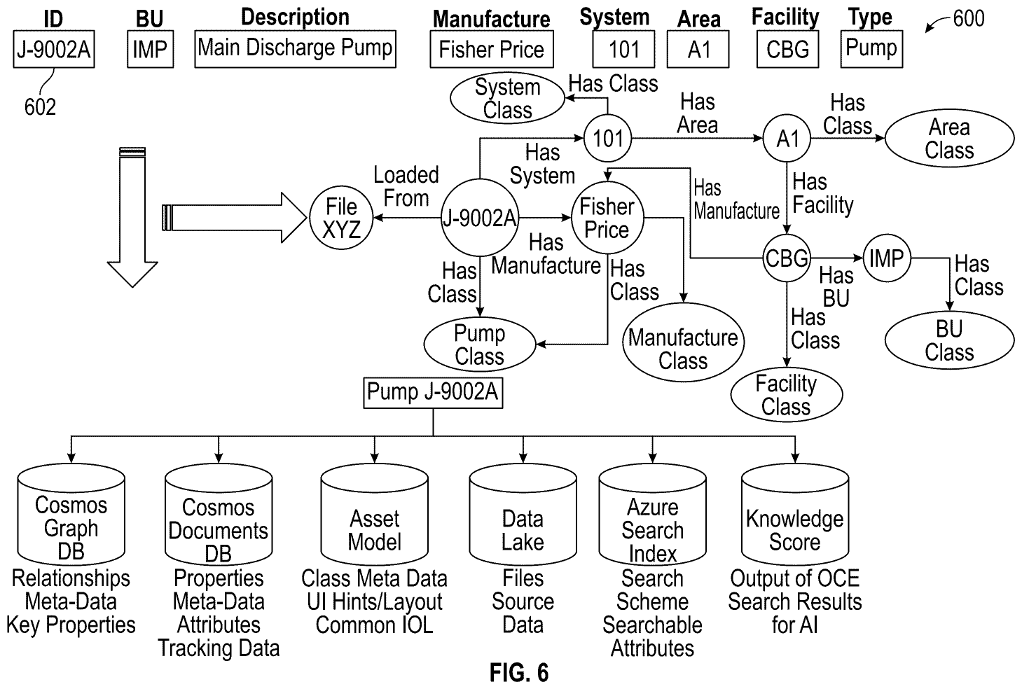

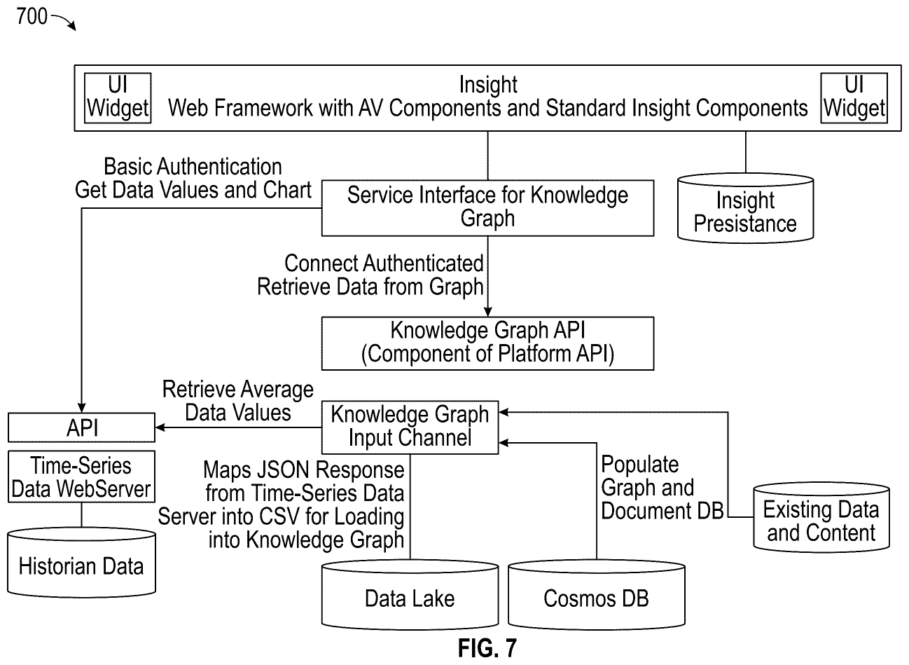

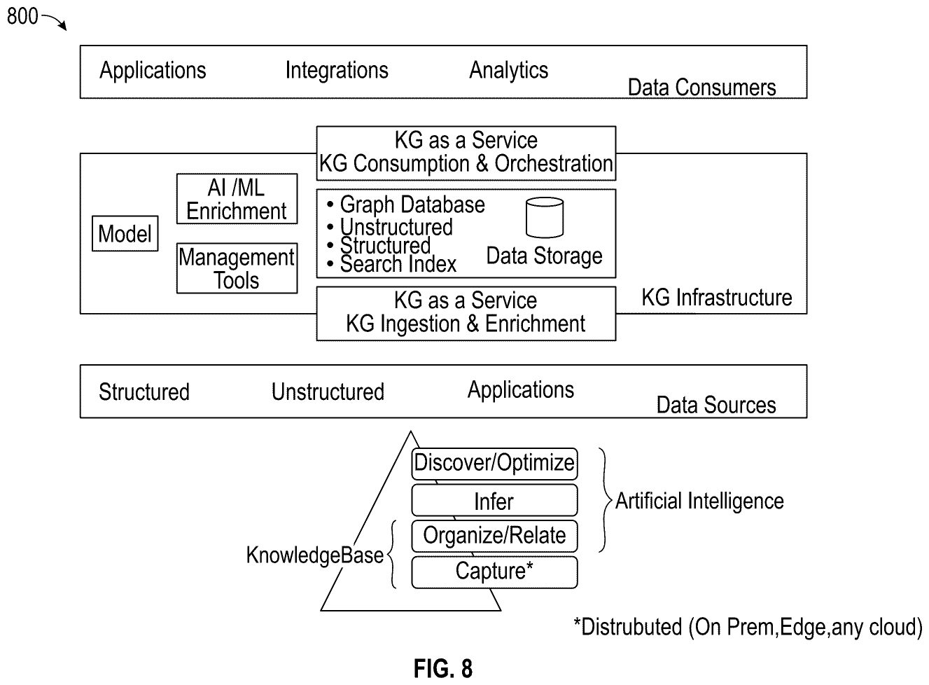

FIG. 6 shows aspects of the system architecture 600 that includes data loading and mapping according to some embodiments. The system can build components in the graph from a single line in a register. The system can execute assumptions in the line of data that enables building a model and create the different elements shown. The model shown in FIG. 6 can be an example of the system architecture 600 that can take input data and build different models depending on industry or customer needs. The data may be loaded into the knowledge graph as a single entity, such as J-9002A, but it is stored in different types of user interface technology components and/or peripheral platforms to enable execution of the knowledge graph to control system outputs. For a single entity, the system can create a unique and deterministic identifier that binds data together across each of the different services. FIG. 7 shows an overview of different aspects 700 of the system architecture 600 according to some embodiments. FIG. 8 illustrates further aspects 800 of the system architecture 600 according to some embodiments.

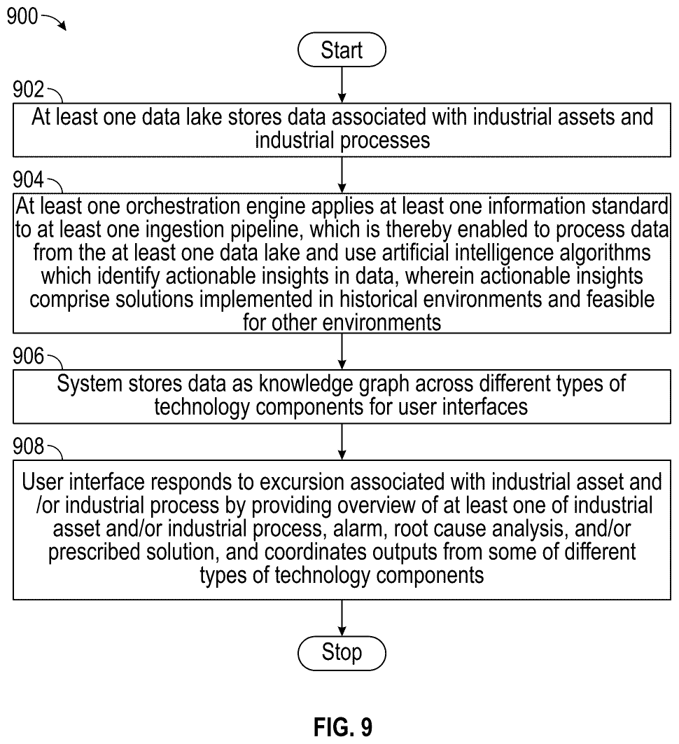

FIG. 9 is a flowchart that illustrates a computer-implemented method for prescriptive intelligent system for mobile industrial workers, under an embodiment. Flowchart 900 depicts method acts illustrated as flowchart blocks for certain actions involved in and/or between the system elements 102-124 of FIG. 1.

At least one data lake stores data associated with industrial assets and industrial processes, block 902. The system received industrial data in a data lake to analyze and use all the types of data. For example, and without limitation, this can include a data lake house storing Acme Energy Corporation's manufacturing data that includes Acme's power plants and wind turbines, which use many industrial assets, such as axial fans.

A data lake can be a centralized repository that stores, processes, and secures large amounts of data in its original form. Data can be information that is processed, stored, and/or transmitted by a computer. An industrial asset can be equipment used in the making of goods and/or the providing of services. An industrial process can be a series of actions or steps undertaken for the making of goods and/or the providing of services.

The data may include physical parameters of the industrial assets. For example, the data includes the physical dimension of the axial cooling fan at the wind turbine, which may be used to render an accurate 3dimensional depiction of the fan. A physical parameter can be a number or other measurable factor related to something tangible.

After at least one data lake stores data, at least one orchestration engine applies at least one information standard to at least one ingestion pipeline, which is thereby enabled to process data from the at least one data lake and use artificial intelligence algorithms which identify actionable insights in the data, wherein actionable insights comprise solutions implemented in historical environments and feasible for other environments, block 904. The system uses artificial intelligence to identify feasible solutions to problems which have yet to be solved in an environment. By example and without limitation, this can include many orchestration engine applying many information standards to many ingestion pipelines to process data from the data lake house and use machine-learning models to identify actionable insights in the data. One such insight is the operators in the power plants respond to axial fans overheating by investigating blockages in a fan's airflow and incorrect electrical supply and worn bearings for the fan's motor, while operators at the wind turbines have corrected problems with overheating axial fans through air flow and electrical supply solutions, but not with a bearing solution.

An orchestration engine can be a tool that automates the coordination and management of computer resources and services. An information standard can be sets of guidelines and formats for communicating data derived by specific high-throughput methods. An ingestion pipeline can be a structured system that imports, processes, and stores data from various sources into a centralized location. An artificial intelligence algorithm can be a set of instructions that allow machines to learn, analyze data, and make decisions based on that knowledge. An actionable insight can be an observation or finding that can be used to make decisions or changes that positively impact a business. A solution can be a means of solving a problem. A historical environment can be the surroundings or conditions in which a business operated in the past. Feasible can be capable of being carried out or done. Another environment can be alternative surroundings or conditions in which a business operates.

Applying the at least one information standard may include applying a same information standard to all data which is processed from all sources of data to ensure that compatible data models are built for industrial assets as needed by system users. For example, the ingestion pipeline applies the same information standard to all data being stored to be viewed together so that each industrial asset is depicted in the correct proportion to the other industrial assets in the same industrial plant. A same information standard can be identical sets of guidelines and formats for communicating data derived by specific high-throughput methods. A source can be a place, person, or thing from which something comes or can be obtained. A compatible data model can be simplified descriptions of a system to assist calculations and predictions for a set of values of variables and which can occur together without conflict. A system user can be a person who operates a computer

An artificial intelligence algorithm may be a machine learning algorithm which is trained on historical data associated with the industrial assets and the industrial processes. For example, a machine-learning algorithm learned that the operators at the wind turbine operators had not attempted the motor bearing temperature solution previously. A machine-learning algorithm can be an application of artificial intelligence that provides a system with the ability to automatically learn and improve from experience without being explicitly programmed. Historical data can be information that is associated with the past and is processed, stored, and/or transmitted by a computer.

Following an ingestion pipeline processing data, a system stores the data as a knowledge graph across different types of technology components for user interfaces, block 906. The system prepares different technology components to simultaneously respond with different but supplementary versions of data on user interfaces. In embodiments, this can include the system storing the data as a knowledge graph across different types of user interface technology components, which provide overviews, 3-D depictions, and key performance indicator for malfunctioning assets. A system can be a set of things working together as parts of a mechanism or an interconnecting network. A knowledge graph can be a representation of a network of real-world entities—such as objects, events, situations or concepts—and illustrates the relationship between them. A different type can be a category having disparate characteristics. A technology component can be a category of scientific knowledge applied to a user interface. A user interface can be the means by which a human and a computer system interact, in particular the use of input devices and software.

Identifying solutions may include identifying contexts of the identified solutions, and providing the prescribed solution comprises providing a context for the prescribed solution. For example, the suggestion to investigate a novel root cause for overheating fans at Acme's wind turbines: by checking the fan's motor bearings for excessive wear included the context information that specified that the fan's inlet air flows and the motor's electrical supply are normal, but the motor's bearing temperatures are high. A context can be the circumstances that form the setting for an event, statement, or idea, and in terms of which it can be fully understood and assessed.

Subsequent to the system storing the data across different types of technology components for user interfaces, a user interface responds to an excursion associated with an industrial asset and/or an industrial process by providing an overview of at least one of an industrial asset and/or an industrial process, an alarm, a root cause analysis, and/or a prescribed solution, and coordinates outputs from some of the different types of technology components, block 908. The system responds to problems by prescribing a solution, some of which have not been attempted in the problem's environment. For example, and without limitation, this can include a dashboard on a user interface responding to an axial cooling fan for a wind turbine beginning to overheat, by outputting an alarm, an overview, and a 3-D depiction of the fan to an operator, along with a suggestion to investigate a novel root cause for overheating fans at Acme's wind turbines: check the fan's motor bearings for excessive wear because the fan's inlet air flows and the motor's electrical supply are normal, but the motor's bearing temperatures are high. An excursion can be a deviation from a proper course. An overview can be a general summary of something. An alarm can be a notification of danger. A root cause analysis can be a wide range of approaches, tools, and techniques used to uncover causes of problems. A prescribed solution can be a recommended answer to a problem. An output can be the material produced.

The data, which is stored as the knowledge graph across the different types of technology components, may be accessed via at least one application programming interface. For example, when the axial motor at one of Acme's wind turbines began overheating, the system administrator used an application programming interface to retrieve and preview the data for the fan. An application programming interface can be a way for two or more computer programs or components to communicate with each other. The user interface responding to the excursion may include providing at least one of a live trend of a key performance indicator of the operation of an industrial plant, an industrial asset piping and instrumentation diagram, properties which include engineering metadata and which are associated with at least one of the industrial asset or the industrial process, a three-dimensional view of an industrial plant, a three-dimensional view of the industrial asset, a virtual reality view of the industrial asset, or an augmented reality view of the industrial asset. For example, the dashboard included a 3-D depiction of the overheating axial fan at the wind turbine, and a live trend for the key performance indicator of the motor bearing temperature for the fan. A live trend can be a general direction in which something is currently developing or changing. A key performance indicator can be a quantifiable measure used to evaluate the success in meeting objectives for performance. An operation can be the functioning of an enterprise or a facility. An industrial plant can be a place where the making of goods and/or the providing of service takes place. An industrial asset piping and instrumentation diagram can be a detailed visual representation of a process system's components and their interconnections. A property can be an attribute, quality, or characteristic of something. Engineering metadata can be information that describes industrial assets. A three-dimensional view can be a representation of something that has height, width, and depth. A virtual reality view can be a perspective of a computer-generated simulation of an environment that has width depth and height. An augmented reality view can be a technology that superimposes a computer-generated image on a user's perspective of the real world, thus providing a composite perspective.

Although FIG. 9 depicts the blocks 902-908 occurring in a specific order, the blocks 902-912 can occur in another order. In other implementations, each of the blocks 902-908 can also be executed in combination with other blocks and/or some blocks may be divided into a different set of blocks.

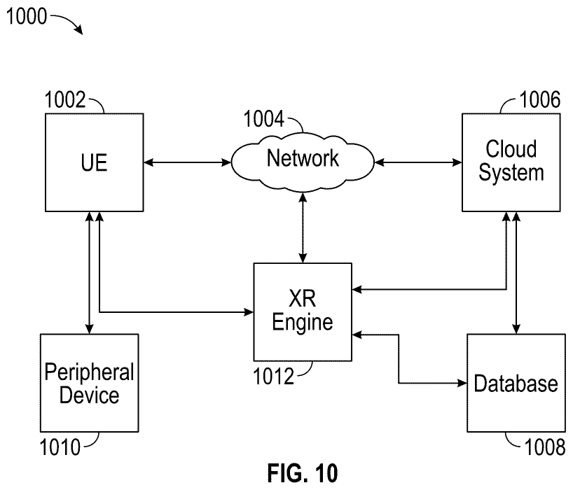

FIG. 10 depicts system 1000 which provides an example embodiment according to components for providing at least one aspect of the system. The system 1000 can include UE 1002 (e.g., a client device), network 1004, cloud system 1006, database 1008, peripheral device 1010, and extended reality (XR) engine 1012. It should be understood that while system 1000 is depicted as including such components, it should not be construed as limiting, as one of ordinary skill in the art would readily understand that varying numbers of UEs, peripheral devices, cloud systems, databases and networks can be utilized.

The UE 1002 can be any type of device, such as a mobile phone, tablet, laptop, sensor, Internet of Things (IoT) device, autonomous machine, and any other device equipped with a cellular or wireless or wired transceiver. The UE 1002 can be a device associated with an individual (or set of individuals), and may correspond to a device having a corresponding peripheral device 1010, as discussed herein.

The network 1004 can be any type of network, such as a wireless network, cellular network, the Internet, and the like, as discussed above. The network 104 facilitates connectivity of the components of system 1000.

The database 1008 may correspond to a data storage for a platform (e.g., a network hosted platform, such as the cloud system 1006, as discussed below) or multiple platforms. The database 1008 may receive storage instructions/requests from, for example, XR engine 1012 (and associated microservices), which may be in any type of known or to be known format, such as, for example, standard query language (SQL). The database 1008 may correspond to a distributed ledger of a distributed network. The distributed network may include multiple distributed network nodes, whereby each distributed network node includes and/or corresponds to a computing device associated with at least one entity (e.g., the entity associated with the cloud system 1006, for example, discussed below). Each distributed network node may include at least one distributed network data store configured to store distributed network-based data objects for the at least one entity. For example, the database 1008 may correspond to a blockchain, where the distributed network-based data objects can include account information, medical information, entity identifying information, wallet information, device information, network information, credentials, security information, permissions, identifiers, smart contracts, transaction history, and the like, or any other type of known or to be known data/metadata related to an entity's and/or user's information, structure, business and/or legal demographics, inter alia.

The peripheral device 1010 can be connected to the UE 1002, and can be any type of peripheral device, such as a wearable device (e.g., smart watch), printer, speaker, sensor, and the like. The peripheral device 1010 can be any type of device that is connectable to the UE 1002 via any type of known or to be known pairing mechanism, such as Bluetooth™, Bluetooth Low Energy (BLE), NFC, and the like.

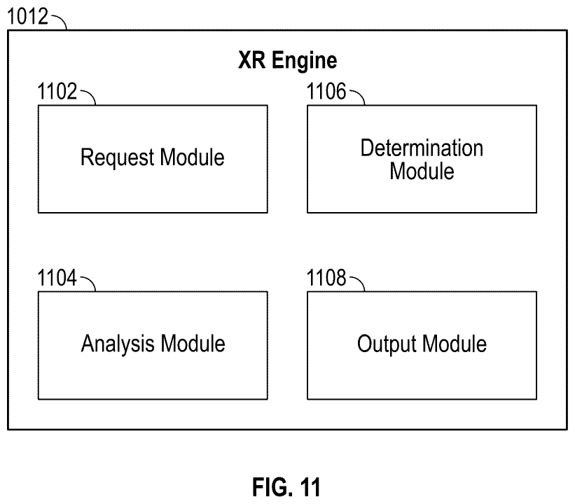

FIG. 11 shows the XR engine 1012 including a request module 1102, analysis module 1104, determination module 1106, and the output module 1108 according to some embodiments. It should be understood that the engine(s) and modules discussed herein are non-exhaustive, as additional or fewer engines and/or modules (or sub-modules) may be applicable to the embodiments of the systems and methods discussed.

The XR engine 1012 can include components for the disclosed functionality. The XR engine 1012 may be a special purpose machine or processor and can be hosted by a device on the network 1004, within the cloud system 1006 and/or on the UE 1002 (and/or the peripheral device 1010). The XR engine 1012 may be hosted by a server and/or set of servers associated with the cloud system 1006. As discussed in more detail below, the XR engine 1012 may be configured to implement and/or control multiple services and/or microservices, where each of the multiple services and/or microservices are configured to execute multiple workflows associated with performing the disclosed functionality. The XR engine 1012 may function as an application provided by the cloud system 1006.

The XR engine 1012 may function as an application installed on a server(s), network location and/or other type of network resource associated with the cloud system 1006. The XR engine 1012 may function as application installed and/or executing on the UE 1002. Such am application may be a web-based application accessed by the UE 1002 and/or devices associated with the peripheral device 1010 over the network 1004 from the cloud system 1006. The XR enginc 1012 may be configured and/or installed as an augmenting script, program or application (e.g., a plug-in or extension) to another application or program provided by the cloud system 1006 and/or executing on the UE 1002 and/or the peripheral device 1010.

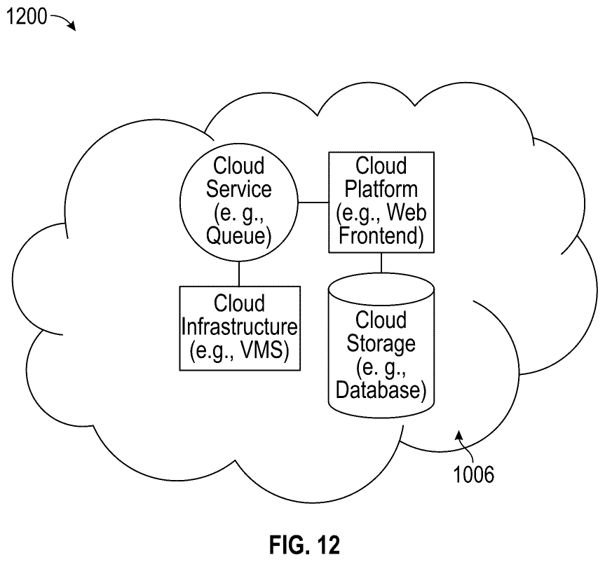

FIG. 12 depicts the cloud system 1006 according to some embodiments. The cloud system 1006 may be any type of cloud operating platform and/or network-based system upon which applications, operations, and/or other forms of network resources may be located. For example, the cloud system 1006 may be a service provider and/or network provider from where services and/or applications may be accessed, sourced or executed from. For example, the cloud system 1006 can represent the cloud-based architecture, which has associated network resources hosted on the internet or private network (e.g., the network 1004), which enables (via the XR engine 1012) creation, hosting and/or interaction, as discussed herein. The cloud system 1006 may include a server(s) and/or a database of information which is accessible over the network 1004. The database 1008 of the cloud system 1006 may store a dataset of data and metadata associated with local and/or network information related to a user(s) of the UE 1002, the peripheral/device 110, and the UE 1002 and the services and applications provided by the cloud system 106 and/or the XR engine 1012. For example, the cloud system 106 can provide a private/proprietary industrial software platform, whereby the XR engine 1012, discussed below, corresponds to the novel functionality cloud system 1006 enables, hosts and provides to the cloud system 1006 the network 1004 and other devices/platforms operating thereon.

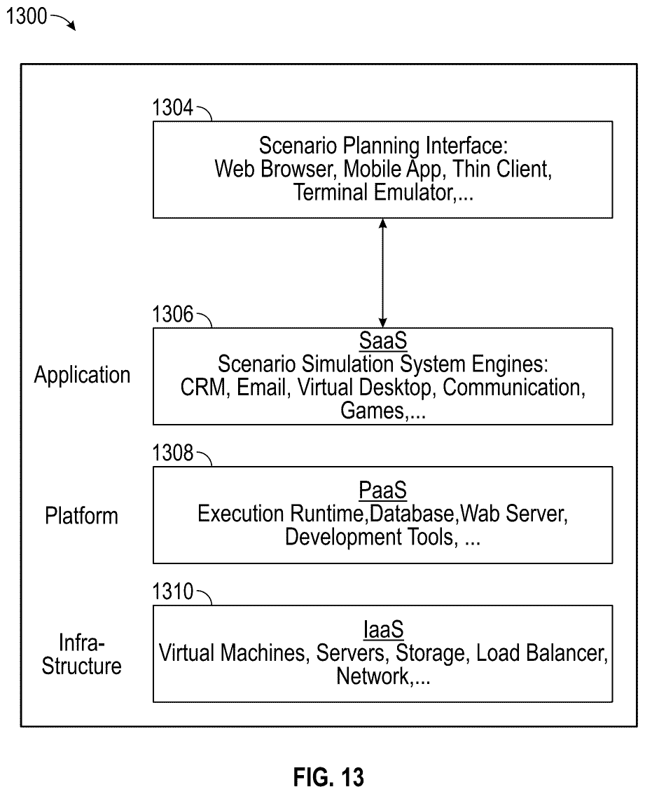

FIG. 13 shows the exemplary computer-based systems/platforms, the exemplary computer-based devices, and/or the exemplary computer-based components of the present disclosure according to some embodiments, which may be specifically configured to operate in the cloud computing/architecture 1006 such as a web browser, mobile app, thin client, terminal emulator or other endpoint 1304, software as a service (SaaS) 1306, platform as a service (PaaS) 1308, and/or an: infrastructure a service (IaaS) 1310. FIG. 13 illustrate schematics of non-limiting implementations of the cloud computing/architecture(s) in which the exemplary computer-based systems for administrative customizations and control of network-hosted application programming interfaces of the present disclosure may be specifically configured to operate.

Accordingly, such functionalities can be provided by local and/or web-hosted modules that can execute so as to realize the operational environment via the system. The system environment, embodied as a product, can be provided via Cloud functionality, which can allow enterprise users to scan an industrial plant and/or its associated assets so as to enable the industrial plant and/or its assets to be reviewed and/or monitored. Such scanning/review can enable the replication of such industrial plant/assets as IOs within AR/VR/MR/XR environments, where the IOs consume all standard features of the industrial plant/assets.

The system environment, embodied as a project, can be provided via Cloud functionality, which can allow enterprise users to view a pre-defined and published industrial plant(s) and/or asset. Accordingly, the scanning/review/consumption of the industrial plant and/or its assets can be configured as with the product discussed above, and the XR engine 1012 can enable the engagement with the space. The system may require the XR engine 1012 to import the industrial assets and plant information to enable the scripting of the industrial plant/assets behaviors (e.g., in addition to the scripting available via a template(s)), and to deploy the final release to the Cloud/storage. This can have a high impact on SIs.

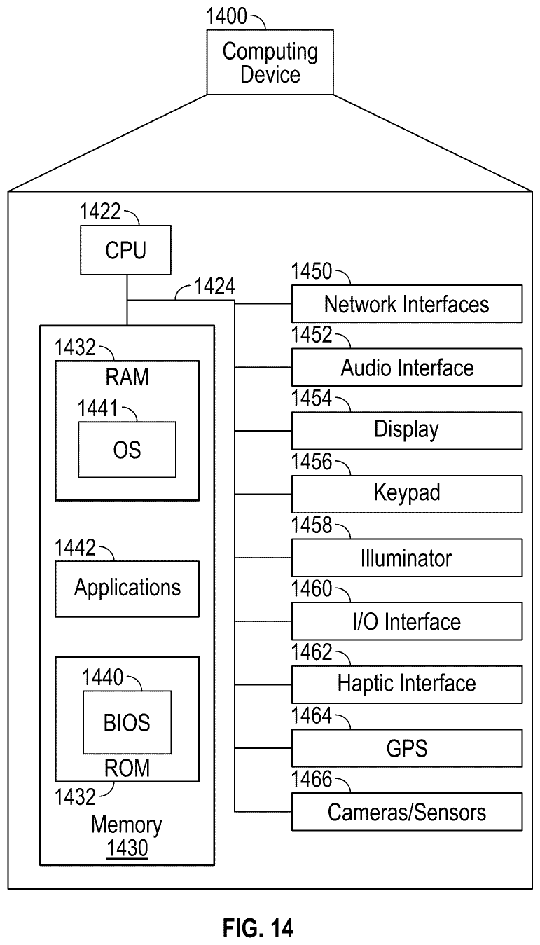

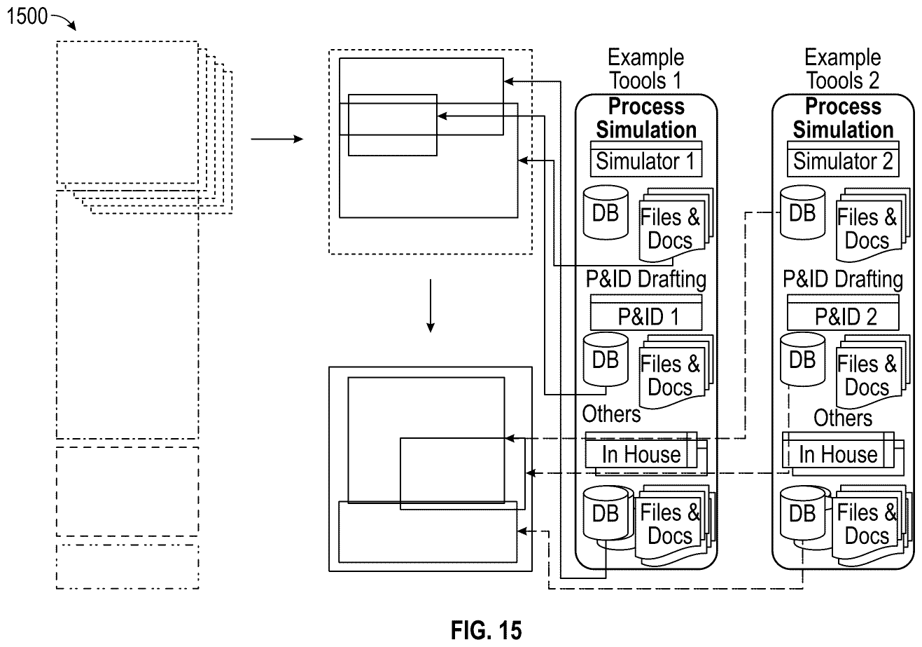

FIG. 14 depicts a schematic diagram illustrating an example embodiment of a client device 1400 that may be used within the present disclosure according to some embodiments. However, the components shown are sufficient to disclose an illustrative embodiment for implementing the present disclosure. FIG. 15 shows the system integrated into a process model according to some embodiments.

The client device 1400 may include a processing unit (CPU) 1422 in communication with a mass memory 1430 via a bus 1424. The client device 1400 also includes a power supply 1426, at least one network interfaces 1450, an audio interface 1452, a display 1454, a keypad 1456, an illuminator 1458, an input/output interface 1460, a haptic interface 1462, an optional global positioning systems (GPS) receiver 1464 and a camera(s) or other optical, thermal or electromagnetic sensors 1466. The client device 1400 can include one camera/sensor 1466, or multiple cameras/sensors 1466, as understood by those of skill in the art. The power supply 1426 provides power to the client device 1400.

The client device 1400 may optionally communicate with a base station (not shown), or directly with another computing device. A network interface 1450 may sometimes be known as a transceiver, or network interface card (NIC). An audio interface 1452 is arranged to produce and receive audio signals such as the sound of a human voice. A display 1454 may be a liquid crystal display (LCD), gas plasma, light emitting diode (LED), or any other type of display used with a computing device. The display 1454 may also include a touch sensitive screen arranged to receive input from an object such as a stylus or a digit from a human hand.

A keypad 1456 may include any input device arranged to receive input from a user. An illuminator 1458 may provide a status indication and/or provide light. The client device 1400 also includes an input/output interface 1460 for communicating externally. An input/output interface 1460 can utilize at least one communication technologies, such as USB, infrared, Bluetooth™, or the like. A haptic interface 1462 is arranged to provide tactile feedback to a user of the client device.

The optional GPS transceiver 1464 can determine the physical coordinates of the client device 1400 on the surface of the Earth, which typically outputs a location as latitude and longitude values. The GPS transceiver 1464 can also employ other geo-positioning mechanisms, including triangulation, assisted GPS (AGPS), E-OTD, CI, SAI, ETA, BSS or the like, to further determine the physical location of the client device 1400 on the surface of the Earth. However, the client device 1400 may, through other components, provide other information that may be employed to determine a physical location of the device, including for example, a MAC address, Internet Protocol (IP) address, or the like.

The mass memory 1430 includes a RAM 1432, a ROM 1434, and other storage means. The mass memory 1430 illustrates another example of computer storage media for storage of information such as computer readable instructions, data structures, program modules or other data. The mass memory 1430 stores a basic input/output system (“BIOS”) 1440 for controlling low-level operation of the client device 1400. The mass memory 1430 also stores an operating system 1441 for controlling the operation of the client device 1400.

The mass memory 1430 further includes at least one data stores, which can be utilized by the client device 1400 to store, among other things, applications 1442 and/or other information or data. For example, data stores may be employed to store information that describes various capabilities of the client device 1400. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within the client device 1400.

The applications 1442 may include computer executable instructions which, when executed by the client device 1400, transmit, receive, and/or otherwise process audio, video, images, and enable telecommunication with a server and/or another user of another client device. The applications 1442 may further include a client that is configured to send, to receive, and/or to otherwise process gaming, goods/services and/or other forms of data, messages and content hosted and provided by the platform associated with the XR engine 1012 and its affiliates. As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The at least one processors may be implemented as a Complex Instruction Set Computer (CISC) or Reduced Instruction Set Computer (RISC) processors, x86 instruction set compatible processors, multi-core, or any other microprocessor or central processing unit (CPU). In various implementations, the at least one processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to at least one servers or be loaded and executed by at least one servers. At least one modules may be grouped into an engine or an application.

At least one aspect of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, non-transitory machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with at least one principles of the present disclosure may be downloadable from a network, for example, a website, as a stand-alone product or as an add-in package for installation in an existing software application. For example, exemplary software specifically programmed in accordance with at least one principles of the present disclosure may also be available as a client-server software application, or as a web-enabled software application. For example, exemplary software specifically programmed in accordance with at least one principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

The disclosure describes the specifics of how a machine including at least one computer comprising at least one processor and at least one non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms: Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured. “Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer.

When defined as a special purpose computer, the computer can also perform other processing, program execution or routines that are not part of the special purpose, while still being capable of operating for the special purpose. Alternatively, the operations can be processed by a general-purpose computer selectively activated or configured by at least one computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, which can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. The manipulation can be performed by a processor. In such an example, the processor thus transforms the data from one thing to another.

Still further, some embodiments include methods can be processed by at least one machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A system for a prescriptive intelligent system for mobile industrial workers, the system comprising:
at least one processor; and
a non-transitory computer readable medium storing a plurality of instructions, which when executed, cause the at least one processor to:
store, by at least one data lake house, data associated with industrial assets and industrial processes;
apply, by at least one orchestration engine, at least one information standard to at least one ingestion pipeline which is thereby enabled to process data from the at least one data lake house and use artificial intelligence algorithms which identify actionable insights in the data, wherein actionable insights comprise solutions implemented in historical environments and feasible for other environments;
store the data as a knowledge graph across different types of technology components for user interfaces; and
provide, by a user interface, at least one of an overview of at least one of an industrial asset or an industrial process, an alarm, a root cause analysis, and a prescribed solution, wherein the user interface coordinates outputs from some of the different types of technology components, in response to an excursion associated with at least one of the industrial asset or the industrial process.

2. The system of claim 1, wherein the data comprises physical parameters of the industrial assets.

3. The system of claim 1, wherein applying the at least one information standard comprises applying a same information standard to all data which is processed from all sources of data to ensure that consistent and coherent data models are built for industrial assets as needed by system users.

4. The system of claim 1, wherein the artificial intelligence algorithms comprise machine learning algorithms which are trained on historical data associated with the industrial assets and the industrial processes.

5. The system of claim 1, wherein the data, which is stored as the knowledge graph across the different types of technology components, is accessed via at least one application programming interface.

6. The system of claim 1, wherein identifying solutions comprises identifying contexts of the identified solutions, and providing the prescribed solution comprises providing a context for the prescribed solution.

7. The system of claim 1, wherein the user interface responding to the excursion comprises provides at least one of a live trend of a key performance indicator of the operation of an industrial plant, an industrial asset piping and instrumentation diagram, properties which include engineering metadata and which are associated with at least one of the industrial asset or the industrial process, a three-dimensional view of an industrial plant, a three-dimensional view of the industrial asset, a virtual reality view of the industrial asset, or an augmented reality view of the industrial asset.

8. A computer-implemented method for prescriptive intelligent system for mobile industrial workers, the computer-implemented method comprising:
storing by at least one data lake house, data associated with industrial assets and industrial processes;
applying, by at least one orchestration engine, at least one information standard to at least one ingestion pipeline which is thereby enabled to process data from the at least one data lake house and use artificial intelligence algorithms which identify actionable insights in the data, wherein actionable insights comprise solutions implemented in historical environments and feasible for other environments;
storing the data as a knowledge graph across different types of technology components for user interfaces; and
providing, by a user interface, at least one of an overview of at least one of an industrial asset or an industrial process, an alarm, a root cause analysis, and a prescribed solution, wherein the user interface coordinates outputs from some of the different types of technology components, in response to an excursion associated with at least one of the industrial asset or the industrial process.

9. The computer-implemented method of claim 8, wherein the data comprises physical parameters of the industrial assets.

10. The computer-implemented method of claim 8, wherein applying the at least one information standard comprises applying a same information standard to all data which is processed from all sources of data to ensure that consistent and coherent data models are built for industrial assets as needed by system users.

11. The computer-implemented method of claim 8, wherein the artificial intelligence algorithms comprise machine learning algorithms which are trained on historical data associated with the industrial assets and the industrial processes.

12. The computer-implemented method of claim 8, wherein the data, which is stored as the knowledge graph across the different types of technology components, is accessed via at least one application programming interface.

13. The computer-implemented method of claim 8, wherein identifying solutions comprises identifying contexts of the identified solutions, and providing the prescribed solution comprises providing a context for the prescribed solution.

14. The computer-implemented method of claim 8, wherein the user interface further provides at least one of a live trend of a key performance indicator of the operation of an industrial plant, an industrial asset piping and instrumentation diagram, properties which include engineering metadata and which are associated with at least one of the industrial asset or the industrial process, a three-dimensional view of an industrial plant, a three-dimensional view of the industrial asset, a virtual reality view of the industrial asset, or an augmented reality view of the industrial asset.

15. A computer program product, comprising a non-transitory computer-readable medium having a computer-readable program code embodied therein to be executed by at least one processors, the program code including instructions to:
store, by at least one data lake house, data associated with industrial assets and industrial processes;
apply, by at least one orchestration engine, at least one information standard to at least one ingestion pipeline which is thereby enabled to process data from the at least one data lake house and use artificial intelligence algorithms which identify actionable insights in the data, wherein actionable insights comprise solutions implemented in historical environments and feasible for other environments;
store the data as a knowledge graph across different types of technology components for user interfaces; and
provide, by a user interface, at least one of an overview of at least one of an industrial asset or an industrial process, an alarm, a root cause analysis, and a prescribed solution, wherein the user interface coordinates outputs from some of the different types of technology components, in response to an excursion associated with at least one of the industrial asset or the industrial process.

16. The computer program product of claim 15, wherein the data comprises physical parameters of the industrial assets, and wherein applying the at least one information standard comprises applying a same information standard to all data which is processed from all sources of data to ensure that consistent and coherent data models are built for industrial assets as needed by system users.

17. The computer program product of claim 15, wherein the artificial intelligence algorithms comprise machine learning algorithms which are trained on historical data associated with the industrial assets and the industrial processes.

18. The computer program product of claim 15, wherein the data, which is stored as the knowledge graph across the different types of technology components, is accessed via at least one application programming interface.

19. The computer program product of claim 15, wherein identifying solutions comprises identifying contexts of the identified solutions, and providing the prescribed solution comprises providing a context for the prescribed solution.

20. The computer program product of claim 15, wherein the user interface further provides at least one of a live trend of a key performance indicator of the operation of an industrial plant, an industrial asset piping and instrumentation diagram, properties which include engineering metadata and which are associated with at least one of the industrial asset or the industrial process, a three-dimensional view of an industrial plant, a three-dimensional view of the industrial asset, a virtual reality view of the industrial asset, or an augmented reality view of the industrial asset.
